(19) United States
(12) Patent Application Publication
(10) Pub. No.: US 2008/0242549 A1
(43) Pub. Date: Oct. 2, 2008

(54) SUPERCONDUCTING FILTER DEVICE

(75) Inventors: Kazunori YAMANAKA, Kawasaki (JP); Akihiko AKASEGAWA, Kawasaki (JP); Kazuaki KURIHARA, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/054,098

(22) Filed: Mar. 24, 2008

(30) Foreign Application Priority Data
Mar. 27, 2007 (JP) 2007-082176

(51) Int. Cl. H01P 1/20

(52) U.S. Cl. 505/210; 333/204

(57) ABSTRACT

A superconducting filter device is disclosed that includes a dielectric base substrate; a patch-type resonator pattern formed of a superconducting material on the base substrate; and a feeder extending in the vicinity of the resonator pattern. The feeder includes a transmission line part for signal inputting or signal outputting, the transmission line part extending toward the resonator pattern; a facing part bent from the transmission line part to face the resonator pattern; and an end part bent from the facing part in a direction away from the resonator pattern.

### CROSS-REFERENCE TO RELATED APPLICATION

The present application is based on Japanese Priority Patent Application No. 2007-082176, filed on Mar. 27, 2007, the entire contents of which are hereby incorporated by reference.

### BACKGROUND OF THE INVENTION

1. Field of the Invention

The present invention relates generally to superconducting filter devices, and more particularly to the feeder structure of a patch-pattern-type superconducting filter that handles high-frequency signals.

2. Description of the Related Art

Of the high-frequency filters used in the radio base stations of mobile communications systems of several GHz or less, those used for receiving include those of a coaxial resonator type, a dielectric resonator type, and a superconducting resonator type. It is desirable that those filters be small in size and higher in frequency selectivity. In terms of high frequency selectivity, a receiving filter having a resonant circuit using an oxide high-temperature superconductor has an advantage in that a high unloaded Q is obtained.

On the other hand, in the case of forming a filter that handles high power with a superconducting resonator pattern as in the case of those used for transmission, it is difficult to combine power characteristics such as durability to electric power (power handling capability) with size reduction, so that it has become a major issue to combine them.

As an attempt to reduce size and increase power in superconducting filters having a resonator circuit formed of a superconducting material, studies have been made of a method of alleviating current density concentration with a TM mode by shaping the superconducting conductor pattern of the resonator circuit not into a strip but into a circular or polygonal patch (plane figure). Further, studies have also been made of a method of developing and using an oxide high-temperature superconducting film of good quality by attempting to control grain boundaries or impurities.

As techniques of making a passive circuit using an oxide superconductor, those are known of making a high-frequency filter circuit having a resonator circuit of a microstrip-line-type circuit or a coplanar-type circuit formed by forming a film of a copper oxide high-temperature superconductor on a substrate. (See, for example, Non-Patent Documents 1 and 2 listed below.)

Further, there have been proposed a method of alleviating a concentration of current density on a superconductor by combining a disk superconducting resonator pattern and a dielectric other than a base substrate on which the pattern is formed and a transmission line structure where a dielectric is placed on top of the film conductor of a planar circuit. (See, for example, Patent Document 1 listed below.)

As described above, it is important to achieve as much improvement as possible in power characteristics as well as reduction in size in the case of using an oxide superconductor for a high-frequency filter handling high power for transmission. A superconducting filter structure where the superconductor conducting pattern of a resonator circuit is shaped into a circular (disk-type) or polygonal patch is suitable as a transmission filter because of its capability of alleviating current density compared with a linear (line-shaped) pattern widely used for receiving when the passing power is equivalently the same. In this type of resonator, however, consideration should be given to feeder placement. This is because it is desired to make the pattern area as small as possible while keeping good electromagnetic coupling between the resonator pattern and the feeder at high power.

Known techniques of a feeder used with a disk-shaped resonator pattern include the following configurations.

(a) Capacitive electromagnetic coupling is performed by providing a gap between the end part of a feeder line pattern and a disk resonator pattern on a substrate. (See, for example, Patent Document 2 listed below.)

(b) Capacitive electromagnetic coupling is performed by providing a gap between the end part of a feeder line pattern having a flared or T-letter shape and a disk-shaped resonator pattern. (See, for example, Patent Document 3 listed below.) According to this method, the gap being the same, the electromagnetic coupling is relatively strong compared with the method of Patent Document 2.

(c) A feeder line pattern is provided along the periphery of a disk pattern with a gap provided therebetween on a substrate. (See, for example, Patent Document 4.)

In order to strengthen the electromagnetic coupling so as to increase passing power while controlling reflected power in the passband of a bandpass filter in these feeder configurations, it is necessary to make the gap between the feeder and the resonator pattern as narrow as possible.

In the above-described structures of (a) and (b), it is possible to strengthen the electromagnetic coupling by placing a dielectric plate over the gap between the feeder end and the disk resonator pattern. As a result of this, however, the laminated dielectric plate is placed over not only the gap but also the disk-shaped resonator pattern. Accordingly, the design parameters of electromagnetic coupling and disk resonance mode depend on each other, so that the design parameters cannot be controlled independently. Further, it is also necessary to control the gap between the laminated dielectric plate and the base substrate on which the pattern is formed.

Thus, the conventional superconducting filter for high power using a disk resonator pattern has the following problems:

it is difficult to establish electromagnetic coupling between an input/output feeder and a disk resonator pattern;

there is concern about a short circuit or discharge breakdown due to contamination if the feeder is brought close to the resonator pattern for coupling; and

it is difficult to improve the power handling capability of the feeder itself.

[Patent Document 1] Japanese Laid-Open Patent Application No. 7-147501

[Patent Document 2] Japanese Laid-Open Patent Application No. 7-336106

[Patent Document 3] Japanese Laid-Open Patent Application No. 8-46413

[Patent Document 4] Japanese Laid-Open Patent Application No. 10-308611

[Non-Patent Document 1] M. Hein, High-Temperature-Superconductor Thin Films at Microwave Frequencies, Springer, 1999

[Non-Patent Document 2] Jia-Sheng Hong, M. J. Lancaster, Microstrip Filters for Rf/Microwave Applications, John Wiley & Sons Inc, 2001

### SUMMARY OF THE INVENTION

According to an aspect of an embodiment, there is provided a superconducting filter device capable of combining electrical characteristics and reduction in pattern area while maintaining good electromagnetic coupling between a feeder and a resonator pattern formed of a superconducting material.

According to an aspect of an embodiment, there is provided a superconducting filter device including a dielectric base substrate; a patch-type resonator pattern formed of a superconducting material on the base substrate; a feeder extending in a vicinity of the resonator pattern, wherein the feeder includes a transmission line part for one of signal inputting and signal outputting, the transmission line part extending toward the resonator pattern; a facing part bent from the transmission line part to face the resonator pattern; and an end part bent from the facing part in a direction away from the resonator pattern.

### BRIEF DESCRIPTION OF THE DRAWINGS

Other objects, features and advantages of the present invention will become more apparent from the following detailed description when read in conjunction with the accompanying drawings, in which:

FIGS. 1A and 1B are schematic diagrams showing a superconducting filter device according to an embodiment of the present invention;

FIG. 2 is a diagram showing a first configuration of a feeder used in the superconducting filter device of FIGS. 1A and 1B according to the embodiment of the present invention;

FIG. 3 is a graph showing filter characteristics in the case of using the feeder of FIG. 2 according to the embodiment of the present invention;

FIGS. 4A and 4B are diagrams showing a second configuration of the feeder used in the superconducting filter device of FIGS. 1A and 1B according to the embodiment of the present invention;

FIG. 5 is a graph showing filter characteristics in the case of using the feeder of FIGS. 4A and 4B according to the embodiment of the present invention;

FIG. 6 is a graph showing the relationship between La/Lb ratio and electromagnetic coupling in the feeder according to the embodiment of the present invention;

FIG. 7 is a schematic diagram for illustrating an electromagnetic distribution in the TM₁₁ mode according to the embodiment of the present invention;

FIG. 8 is a schematic diagram showing an application of a superconducting filter of the present invention to a two-stage bandpass filter according to the embodiment of the present invention; and

FIG. 9 is a graph showing filter characteristics of the two-stage bandpass filter of FIG. 8 according to the embodiment of the present invention.

### DETAILED DESCRIPTION OF THE PREFERRED EMBODIMENTS

A description is given, with reference to the accompanying drawings, of an embodiment of the present invention. In this embodiment, there are provided an arrangement and configuration that provide good electromagnetic coupling between a disk resonator pattern and a feeder in a superconducting filter device that operates at temperatures less than or equal to 100 K.

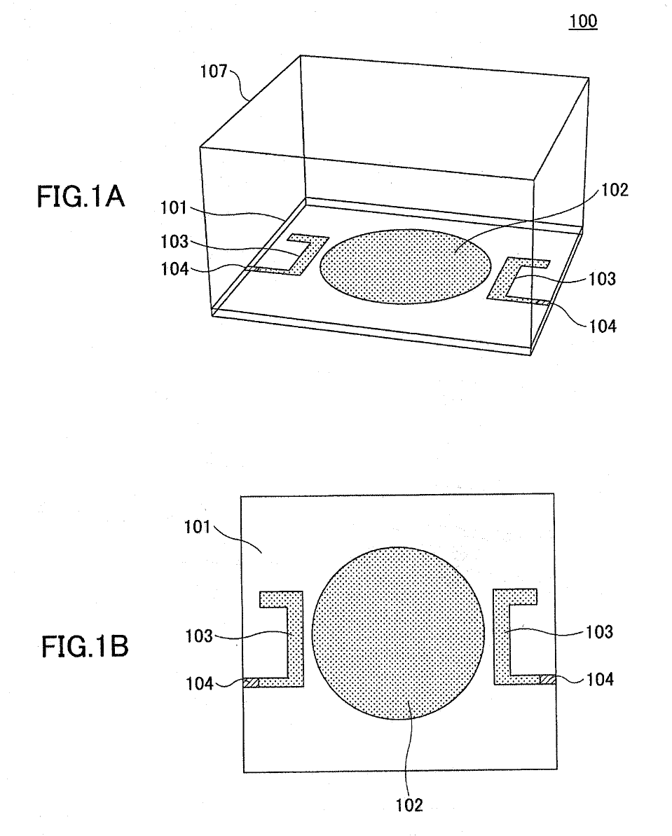

FIGS. 1A and 1B are schematic diagrams showing a superconducting filter device 100 according to the embodiment of the present invention. FIG. 1A is a perspective (phantom) view of the superconducting filter device 100, and FIG. 1B is a plan view of a circuit board. The superconducting filter device 100 of FIGS. 1A and 1B is, for example, a superconducting one-stage bandpass filter. The superconducting filter device 100 includes a dielectric base substrate 101, a disk-shaped resonator pattern 102 formed of a superconducting material on the base substrate 101, and feeders 103 having an angular C-letter shape and provided (extending) in the vicinity of the resonator pattern 102. Each feeder 103 is connected to a corresponding metal electrode 104 for electrical connection to a corresponding external coaxial connector (not graphically illustrated).

The angular-C-letter-shaped feeders 103 are a feeder for input and a feeder for output. These paired feeders 103 are arranged in axial symmetry. The base substrate 101 having the feeders (feeder patterns) 103 and the superconducting resonator pattern 102 thereon is housed in a metal package, whose inner wall 107 is shown in FIG. 1A.

The base substrate 101 is a MgO crystal substrate on whose (100) surface the circuit pattern is formed. According to this example configuration, the base substrate 101 has a thickness of 0.5 mm. The resonator pattern 102 is a disk pattern of 10 mm in diameter formed of a YBCO thin film. For example, YBa₂Cu₃Oₓ (x=6.90 through 6.99) is used as the material of the resonator pattern 102. In the case of FIGS. 1A and 1B, the feeders 103 are also formed of a superconducting material like that of the resonator pattern 102. Further, although not graphically illustrated, a YBCO thin film is formed on the entire bottom surface of the base substrate 101 as a ground film.

The resonator pattern 102 and the feeders 103 are obtained by causing a YBCO film to epitaxially grow on the base substrate 101 in a direction perpendicular thereto so as to have a c-axis crystal orientation and patterning the grown YBCO film. The shortest distance between each feeder 103 and the resonator pattern 102 is, for example, 0.5 mm. By thus providing a relatively large distance between the feeder 103 and the resonator pattern 102, it is possible to significantly reduce the possibility of breakdown due to the quenching or contamination of the feeder part.

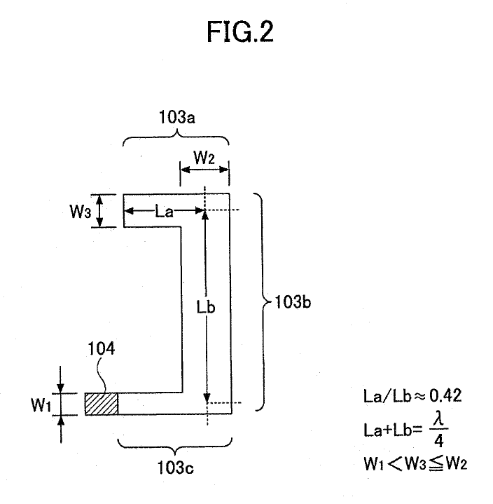

FIG. 2 is a diagram showing a first configuration of the feeder 103. The feeder 103 includes a transmission line part 103c connected to the metal electrode 104, a wide facing part 103b facing the disk resonator pattern 102, and an end part 103a bent from the facing part 103b in a direction away from the resonator pattern 102 so that the feeder 103 has an angular C-letter shape. For example, the end part 103a extends from the facing part 103b at a right or substantially right angle with respect thereto in the direction away from the resonator pattern 102. In this example, the transmission line part 103c has a line width W1 of 0.5 mm, the facing part 103b has a line width W2 of 1 mm, and the end part 103a has a line width W3 of 1 mm.

The relationship of the line widths of these parts 103a through 103c forming the feeder 103 satisfies at least W1<W2, and is preferably W1<W3≦W2. By causing the line width W2 of the facing part 103b facing the resonator pattern 102 and the line width W3 of the bent end part 103a, in particular, the line width W2, to be greater than the line width W1 of the transmission line part 103c, it is possible to alleviate a concentration of current density in the feeder 103 and to improve its power handling capability characteristic. More specifically, the power handling capability characteristic can be approximately quadrupled compared with the case where both the facing part 103b and the end part 103a have the same line width of 0.5 mm as the transmission line part 103c (that is, the input/output characteristic impedance).

Further, letting the length of the end part 103a and the length of the facing part 103b of the feeder 103 be La and Lb, respectively, the total length of La and Lb (La+Lb) is a quarter (¼) of the effective wavelength (λ/4). In the case of FIG. 2, La is 2 mm and Lb is 4.75 mm, so that the value of La/Lb is approximately 0.42.

Here, La may be the distance between the midpoint of the end side of the end part 103a and the intersection point of the center line of the end part 103a in its line width directions and the center line of the facing part 103b in its line width directions. Lb may be the distance between the intersection point of the center line of the end part 103a in its line width directions and the center line of the facing part 103b in its line width directions and the intersection point of the center line of the facing part 103b in its line width directions and the center line of the transmission line part 103c in its line width directions.

By providing the bent end part 103a within the range of La+Lb=λ/4, it is possible to increase the electromagnetic coupling between the feeder 103 and the resonator pattern 102 compared with the case of simply providing an L-letter-shaped feeder.

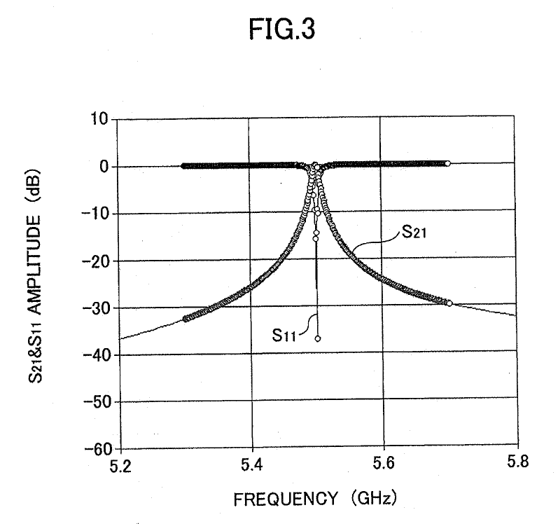

FIG. 3 is a graph showing filter characteristics of the superconducting filter device 100 having the feeder 103 pattern of FIG. 2. This graph shows the results of an electromagnetic simulation in which the conductor part is approximated to a perfect conductor, where S₁₁ indicates a reflection characteristic and S₂₁ indicates a transmission characteristic. The amplitude of S₁₁ indicating signal reflection is as small as −37 dB and signal passage is good at a resonance frequency of 5.5 GHz.

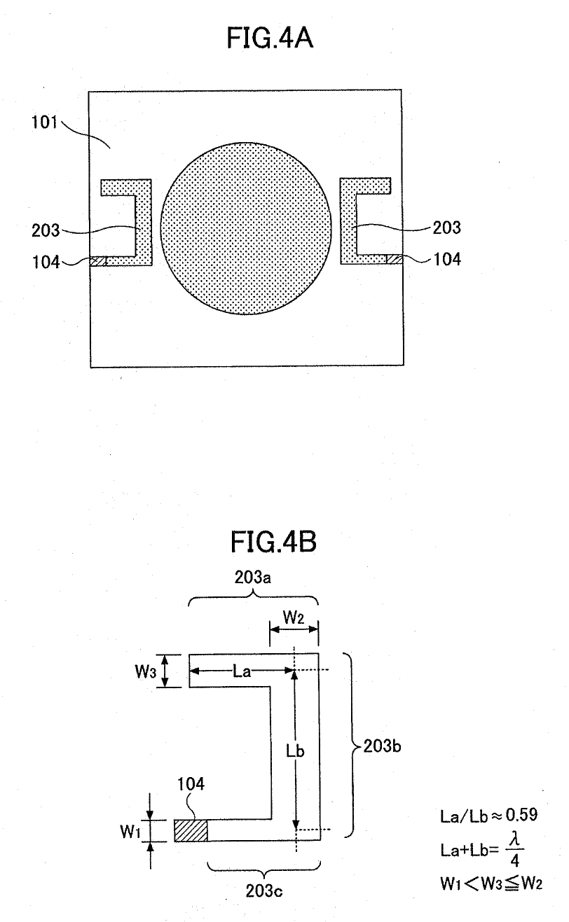

FIGS. 4A and 4B show a second configuration of the feeder 103. In this example, the length La of the bent end part 103a of the feeder 103 is increased so as to have a large La/Lb value. Specifically, La is 2.5 mm and Lb is 4.25 mm. In this case also, the relationship of La+Lb=λ/4 is maintained.

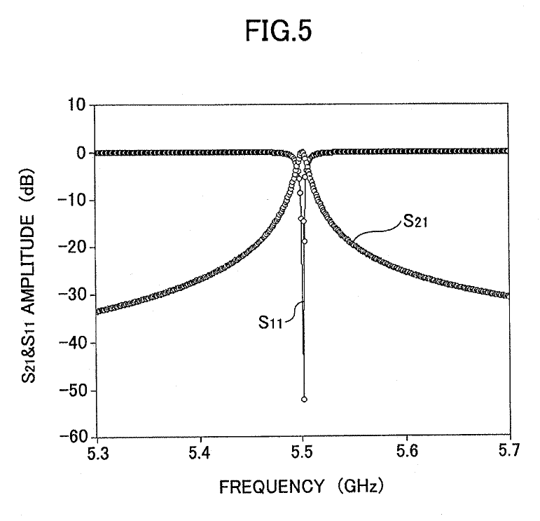

FIG. 5 is a graph showing filter characteristics of the superconducting filter device 100 having the feeder 103 pattern of FIGS. 4A and 4B. The graph shows the results of an electromagnetic simulation in which the conditions are the same as in the case of FIG. 2, that is, the YBCO-thin-film resonator pattern 102 is 10 mm in diameter, the transmission line part 103c of each feeder 103 is 0.5 mm in line width, and the shortest distance between the resonator pattern 12 and the facing part 103b of each feeder 103 is 0.5 mm, and the conductor part is approximated to a perfect conductor.

Compared with the first configuration of FIG. 2, the qualitative effect is the same, but the amplitude of S₁₁ indicating signal reflection is further reduced to −52 dB, in which the effect of the bent end part 103a is evident. The length Lb of the facing part 103b facing the resonator pattern 102 is relatively reduced, but strong electromagnetic coupling is produced by an impedance transforming function. Accordingly, it is possible to obtain low signal reflection and good signal passage characteristics.

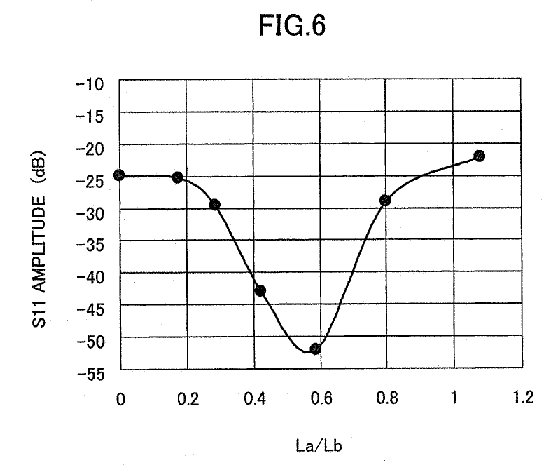

FIG. 6 is a graph showing the relationship between La/Lb ratio and electromagnetic coupling (the results of a simulation of the La/Lb dependence of S₁₁) in the case of increasing the substrate size so as to have a patternable range of 20 mm×16 mm and providing feeder patterns different in La/Lb ratio with reference to the pattern of FIGS. 4A and 4B. The La/Lb ratio is changed with the relationship of La+Lb=λ/4 being maintained, and in the range of 0.2≦(La/Lb)≦0.9, the effect of the angular-C-letter-shaped pattern is seen, showing that good electromagnetic coupling is obtained.

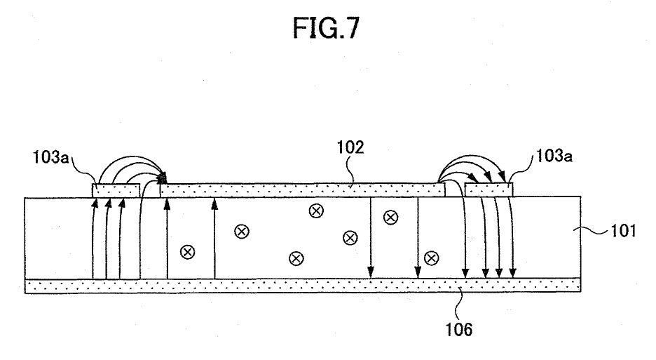

FIG. 7 is a diagram for illustrating the effect of the bent end part 103a of the feeder 103. The superconducting resonator pattern 102 and the feeders 103 (of which only the end parts 103a are shown in FIG. 7) are formed on the surface of the base substrate 101, and a superconducting ground film 106 is formed on the bottom surface of the base substrate 101.

In the TM₁₁ mode, electric field lines extend radially from the peripheral end part of the superconducting resonator pattern 102 to the base substrate 101 or from the base substrate 101 to the resonator pattern 102 as indicated by solid arrows in FIG. 7. Then, as indicated by circled crosses, magnetic fields are formed perpendicularly to the electric field lines. Because of this electric field distribution, it is believed that better electromagnetic coupling can be produced between each feeder 103 and the resonator pattern 102 by placing the end part 103a of the feeder 103 so as to cover an area away from the peripheral end of the resonator pattern 102 within a certain range than by placing the end part 103a of the feeder 103 only in the area near the end part of the resonator pattern 102.

As shown in the simulation results of FIG. 3 and FIG. 5, it is actually possible to produce good electromagnetic coupling by folding back the end part 103a of the feeder 103 within a certain range so that the feeder 103 has an angular C-letter shape while keeping the total length of the end part 103a and the facing part 103b, which are parts of the feeder 103 that contribute to the coupling with the resonator pattern 102, λ/4.

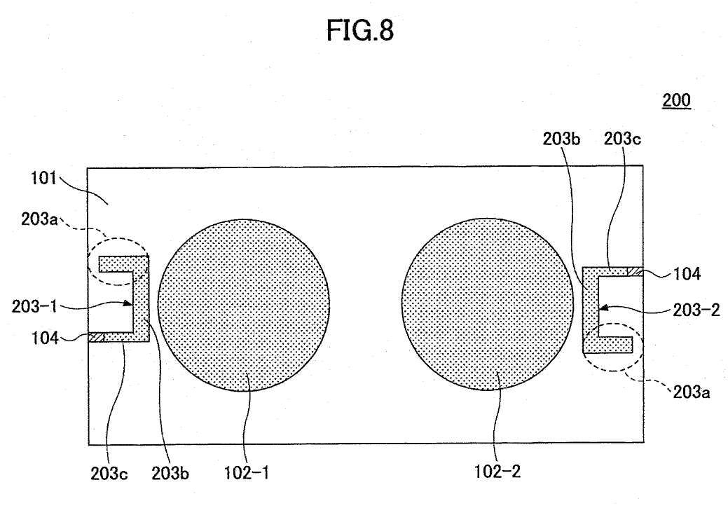

FIG. 8 is a diagram showing an application to a two-stage bandpass filter using two resonators. Referring to FIG. 8, a two-stage bandpass filter 200 includes disk resonator patterns 102-1 and 102-2 formed of a superconducting material on the base substrate 101. Each of the resonator patterns 102-1 and 102-2 is 10 mm in diameter. The superconducting material is a YBCO-system thin film, for example, YBa₂Cu₃Oₓ (x=6.90 through 6.99), the same as in the case of FIG. 1.

A feeder 203-1 extends in the vicinity of the resonator pattern 102-1, and a feeder 203-2 extends in the vicinity of the resonator pattern 102-2. Each of the paired feeders 203-1 and 203-2 has an end part 203a bent so that each of the feeders 203-1 and 203-2 has an angular C-letter shape the same as shown in FIG. 2 or FIGS. 4A and 4B. Unlike in the case of the one-stage bandpass filter 100 of FIGS. 1A and 1B, however, the end parts 203a are arranged in point symmetry or rotational symmetry. In each of the feeders 203-1 and 203-2, the total length of the end part 203a and a facing part 203b facing the corresponding resonator pattern 102-1 or 102-2 is a quarter (¼) of the effective wavelength, and their respective line widths are greater than the line width of a transmission line part 203c.

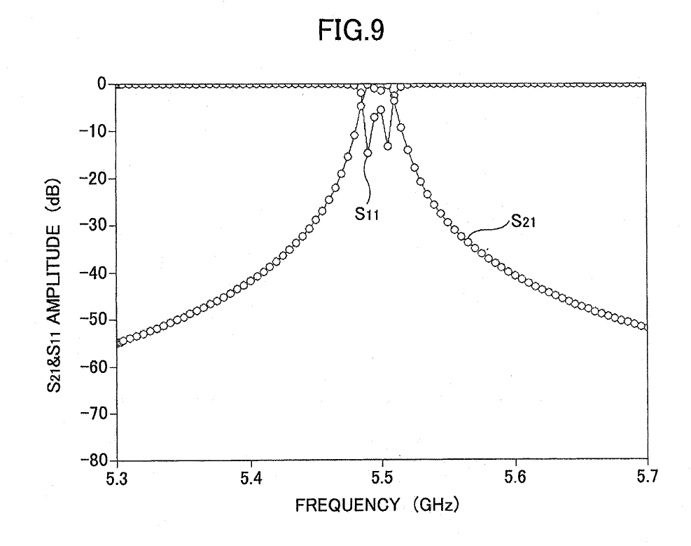

As shown in the graph of FIG. 9, this two-stage bandpass filter 200 presents a good bandpass characteristic of a small minimum passage loss in the band, and shows a quenching power of several W or more at a passage center frequency of 5.5 GHz. By coupling two resonator patterns on the same base substrate into a two-stage bandpass filter, it is possible to reduce size while maintaining filter characteristics compared with the structure of two one-stage filters stacked in layers.

The above-described feeder structures are suitably used for devices handling microwave signals, such as antennas, as well as for filters. In particular, the above-described feeder structures can increase the power characteristic of a feeder itself and provide good coupling with a resonator in high-frequency devices of oxide superconductors handling high power for transmission. Further, since there is no need to force the feeder to be close to the resonator pattern, it is possible to eliminate concern about a short circuit or discharge breakdown due to contamination.

In terms of feeder configuration, the shape of the bent end part is not limited to a corresponding portion of an angular C-letter shape, and may be bent along a direction perpendicular to a tangential line of the resonator pattern, that is, along a radial direction of the resonator pattern, or in a direction away from the resonator pattern at other angles.

Although not graphically illustrated, a triplate-type feeder may be used in place of a microstrip-type feeder used in the embodiment. In this case, the feeder is formed on a surface (of the base substrate) on the side opposite to the patch-type superconducting resonator pattern, and a slit is provided in the base substrate between the resonator pattern and the feeder. The material of the feeder is not limited to superconducting materials, and the feeder may be formed of a metal material.

The shape of the superconducting resonator pattern is not limited to a disk, and may be a shape (patch shape) of a plane figure such as a polygon or ellipse. Aside from Y-system superconducting materials, any oxide superconducting materials may be used as oxide superconductors. For example, RBCO (R—Ba—Cu—O)-system thin films, that is, superconducting materials using Nd, Gd, Sm, or Ho as an R element in place of Y (yttrium) may be used. Further, BSCCO (Bi—Sr—Ca—Cu—O)-system, PBSCCO (Pb—Bi—Sr—Ca—Cu—O)-system, and CBCCO (Cu—Baₚ—Ca_{q}—Cuᵣ—Oₓ; 1.5<p<2.5, 2.5<q<3.5, 3.5<r<4.5)-system superconducting materials may also be used. The dielectric base substrate is not limited to a MgO crystal substrate, and may be, for example, a LaAlO₃ substrate or a sapphire substrate.

According to one aspect of the present invention, it is possible to ensure both sufficient electromagnetic coupling and feeder power handling capability without bringing a feeder close to a resonator pattern compared with the conventional capacitive-coupling-type feeder. Further, there is provided a large process margin in pattern designing, which is advantageous in improving productivity.

The present invention is not limited to the specifically disclosed embodiment, and variations and modifications may be made without departing from the scope of the present invention.

What is claimed is:

1. A superconducting filter device, comprising:
a dielectric base substrate;
a patch-type resonator pattern formed of a superconducting material on the base substrate; and
a feeder extending in a vicinity of the resonator pattern,
wherein the feeder includes
a transmission line part for one of signal inputting and signal outputting, the transmission line part extending toward the resonator pattern;
a facing part bent from the transmission line part to face the resonator pattern; and
an end part bent from the facing part in a direction away from the resonator pattern.

2. The superconducting filter device as claimed in claim 1, wherein the feeder comprises a pair of feeders for the signal inputting and the signal outputting, and the paired feeders are arranged in line symmetry with respect to the resonator pattern.

3. The superconducting filter device as claimed in claim 1, wherein the facing part has a line width greater than a line width of the transmission line part in the feeder.

4. The superconducting filter device as claimed in claim 1, wherein La+Lb=λ/4 holds in the feeder, where La is a length of the end part, Lb is a length of the facing part, and λ is an effective wavelength.

5. The superconducting filter device as claimed in claim 4, wherein 0.2≦(La/Lb)≦0.9 holds in the feeder.

6. The superconducting filter device as claimed in claim 1, wherein W1<W3<W2 holds in the feeder, where W1 is a line width of the transmission line part, W2 is a line width of the facing part, and W3 is a line width of the end part.

7. The superconducting filter device as claimed in claim 1, further comprising:
an additional resonator pattern placed adjacently to the resonator pattern on the dielectric base substrate; and
an additional feeder paired with the feeder, the additional feeder extending in a vicinity of the additional resonator pattern,
wherein the paired feeders are arranged in one of point symmetry and rotational symmetry with respect to the two resonator patterns.

8. The superconducting filter device as claimed in claim 1, wherein the feeder is a pattern having an angular C-letter shape.

9. The superconducting filter device as claimed in claim 1, wherein the feeder has one of a microstrip-type structure and a triplate-type structure.

10. The superconducting filter device as claimed in claim 1, wherein the feeder comprises one of a superconducting material and a metal material.
